(19) United States
(12) Patent Application Publication
(10) Pub. No.: US 2016/0149289 A1
(43) Pub. Date: May 26, 2016

(54) APPARATUS AND METHODS FOR WIRELESS COMMUNICATION

(71) Applicant: NOKIA TECHNOLOGIES OY, Espoo (FI)

(72) Inventors: Juha Lilja, Tampere (FI); IIkka Yli-Peltola, Tampere (FI)

(21) Appl. No.: 14/905,996

(22) PCT Filed: Jul. 7, 2014
(86) PCT No.: PCT/FI2014/050561

§ 371 Date: Jan. 19, 2016

(30) Foreign Application Priority Data
Jul. 19, 2013 (GB) 1312906.9

(51) Int. Cl. H01Q 1/24; H02J 7/02; H04B 5/00

(52) U.S. Cl. CPC H01Q 1/243; H04B 5/0037; H02J 7/025

(57) ABSTRACT

An apparatus comprising: a cover member (24) defining an exterior surface of an electronic device, the cover member (24) including a conductive portion (34) defining an aperture (46) enclosed by the conductive portion (34); the aperture (46) comprising: a first aperture portion (48) configured to extend across a first part (38) of an antenna (26) in a first direction (parallel to the Y axis 32); and a second aperture portion (50) configured to be located outside of an area defined by the antenna (26), the second aperture portion (50) extending in at least a second direction (parallel to the X axis 30), different to the first direction (parallel to the Y axis 32), from the first aperture portion (48).

### TECHNOLOGICAL FIELD

Embodiments of the present invention relate to apparatus and methods for wireless communication. In particular, they relate to apparatus in portable electronic devices.

### BACKGROUND

Apparatus, such as electronic devices, may include an antenna arrangement to enable the electronic device to wirelessly communicate with other devices and/or to enable wireless charging. The antenna arrangement is usually provided within a cover of the electronic device to shield the antenna arrangement from damage caused by the environment and from contact with the user.

The cover of the electronic device defines at least part of the exterior surface of the electronic device and may at least partly comprise a metal or any other conductive material. Such a cover is relatively strong and may also have an attractive aesthetic appearance. However, the conductive material in the cover may reduce the efficiency and range of the antenna arrangement.

It would therefore be desirable to provide an alternative apparatus.

### BRIEF SUMMARY

According to various, but not necessarily all, embodiments of the invention there is provided an apparatus comprising: a cover member defining an exterior surface of an electronic device, the cover member including a conductive portion defining an aperture enclosed by the conductive portion; the aperture comprising: a first aperture portion configured to extend across a first part of an antenna in a first direction; and a second aperture portion configured to be located outside of an area defined by the antenna, the second aperture portion extending in at least a second direction, different to the first direction, from the first aperture portion.

The second direction may be orthogonal to the first direction.

The second aperture portion may be located at an end of the first aperture portion.

The first aperture portion and the second aperture portion have widths, the width of the second aperture portion may be greater than the width of the first aperture portion.

The aperture may further comprise: a third aperture portion configured to extend across a second part of the antenna in a third direction; and a fourth aperture portion configured to be located outside of the area defined by the antenna, the fourth aperture portion extending in a fourth direction, different to the third direction, from the third aperture portion.

The apparatus may further comprise an antenna defining an area and including at least a first part, the antenna being positioned adjacent the aperture.

The apparatus may further comprise charging circuitry, the antenna may be coupled to the charging circuitry.

The apparatus may further comprise radio frequency circuitry, the antenna may be coupled to the radio frequency circuitry.

The antenna may be positioned internal to the cover member.

The antenna may be positioned external to the cover member.

The apparatus may further comprise a camera positioned internal to the cover member and underlying at least a portion of the aperture.

The cover member may be configured to form a rear cover for the electronic device.

According to various, but not necessarily all, embodiments of the invention there is provided an electronic device comprising an apparatus as described in any of the preceding paragraphs.

According to various, but not necessarily all, embodiments of the invention there is provided a method comprising: providing a cover member defining an exterior surface of an electronic device, the cover member including a conductive portion defining an aperture enclosed by the conductive portion; the aperture comprising: a first aperture portion configured to extend across a first part of an antenna in a first direction; and a second aperture portion configured to be located outside of an area defined by the antenna, the second aperture portion extending in at least a second direction, different to the first direction, from the first aperture portion.

The second direction may be orthogonal to the first direction.

The second aperture portion may be located at an end of the first aperture portion.

The first aperture portion and the second aperture portion have widths, the width of the second aperture portion may be greater than the width of the first aperture portion.

The aperture may further comprise: a third aperture portion configured to extend across a second part of the antenna in a third direction; and a fourth aperture portion configured to be located outside of the area defined by the antenna, the fourth aperture portion extending in a fourth direction, different to the third direction, from the third aperture portion.

The method may further comprise positioning an antenna adjacent the aperture, the antenna may define an area and may include at least a first part.

The method may further comprise coupling the antenna to charging circuitry.

The method may further comprise coupling the antenna to radio frequency circuitry.

The antenna may be positioned internal to the cover member.

The antenna may be positioned external to the cover member.

The method may further comprise positioning a camera to be internal to the cover member and underlying at least a portion of the aperture.

The cover member may be configured to form a rear cover for the electronic device.

According to various, but not necessarily all, embodiments of the invention there is provided an apparatus comprising: a cover member defining an exterior surface of an electronic device, the cover member including a conductive portion defining an aperture enclosed by the conductive portion; the aperture comprising: a first aperture portion configured to extend across a first part of an antenna in a first direction; and a second aperture portion configured to be located outside of an area defined by the antenna, wherein the first aperture portion and the second aperture portion have widths, the width of the second aperture portion being greater than the width of the first aperture portion.

### BRIEF DESCRIPTION

For a better understanding of various examples that are useful for understanding the brief description, reference will now be made by way of example only to the accompanying drawings in which:

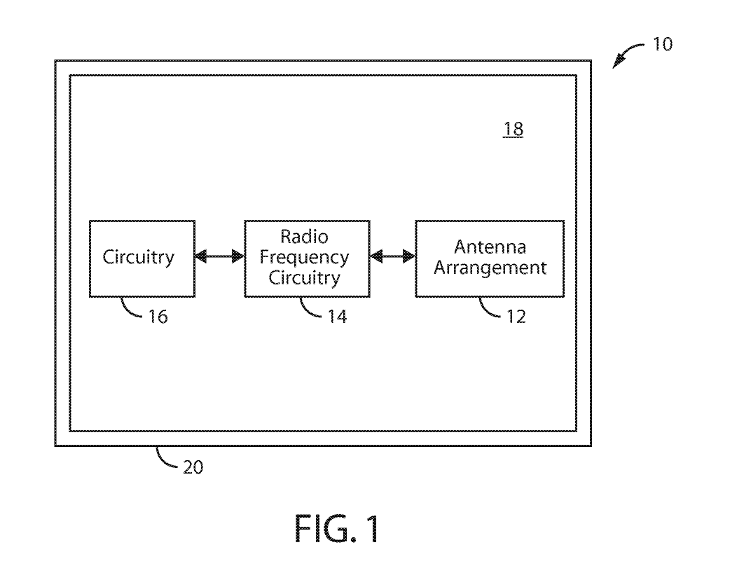

FIG. 1 illustrates a schematic diagram of an electronic device according to various examples;

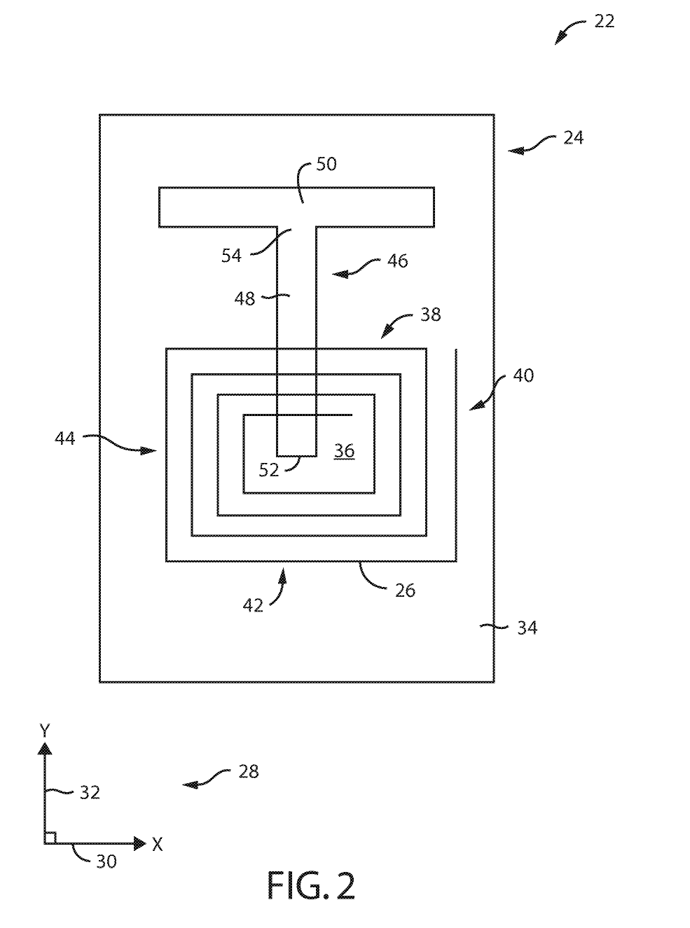

FIG. 2 illustrates a plan view of an apparatus according to various examples;

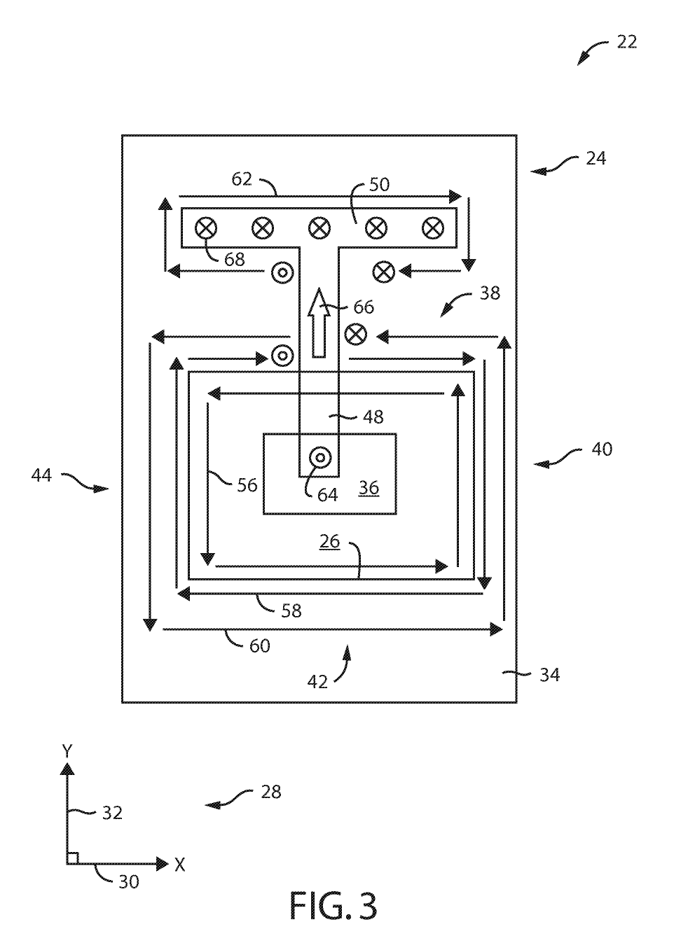

FIG. 3 illustrates a plan view of the apparatus illustrated in FIG. 2 in operation where electrical current and magnetic field lines are illustrated;

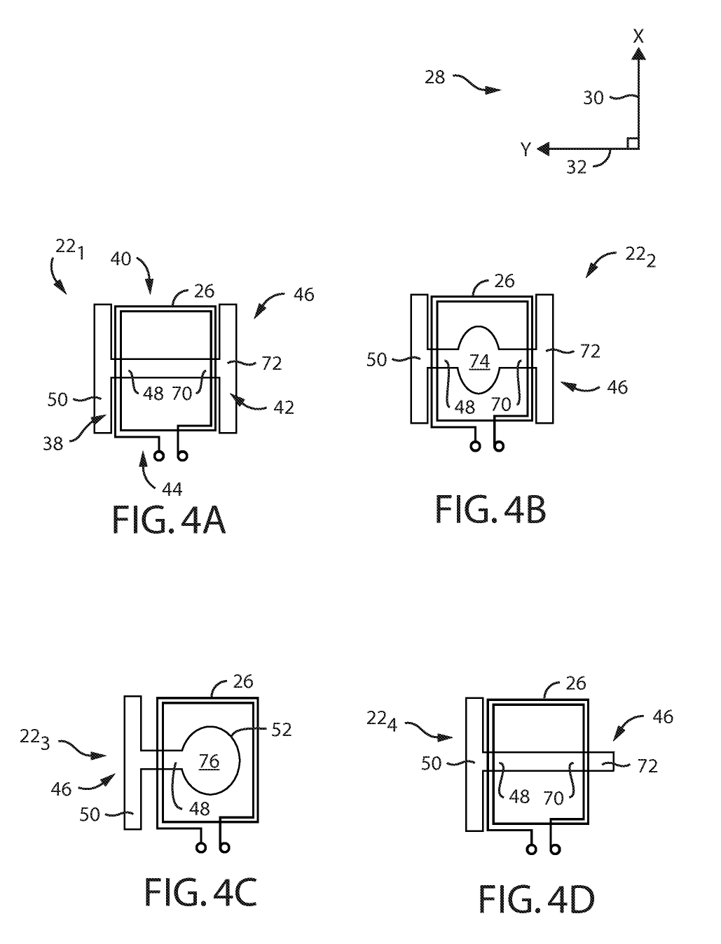

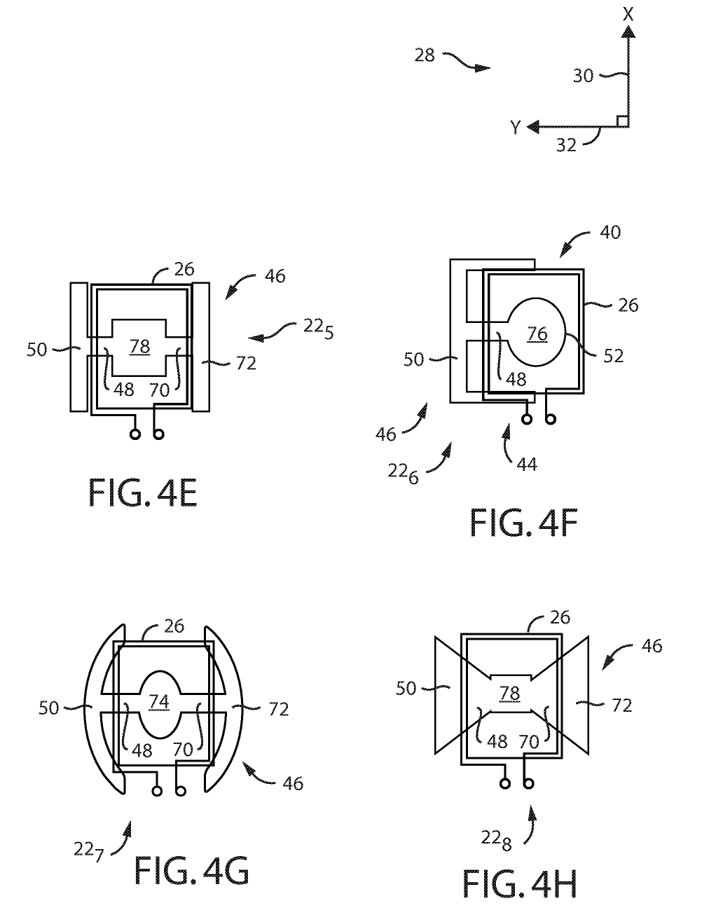

FIGS. 4A to 4H illustrate plan views of various apparatus according to various examples;

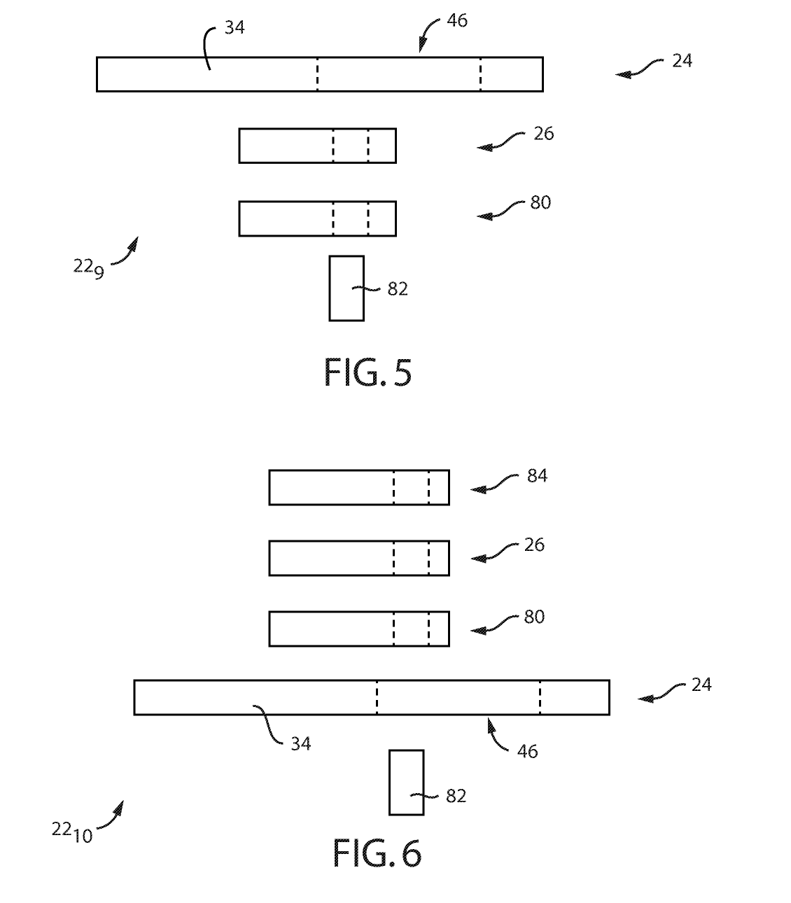

FIG. 5 illustrates a side view of another apparatus according to various examples;

FIG. 6 illustrates a side view of a further apparatus according to various examples;

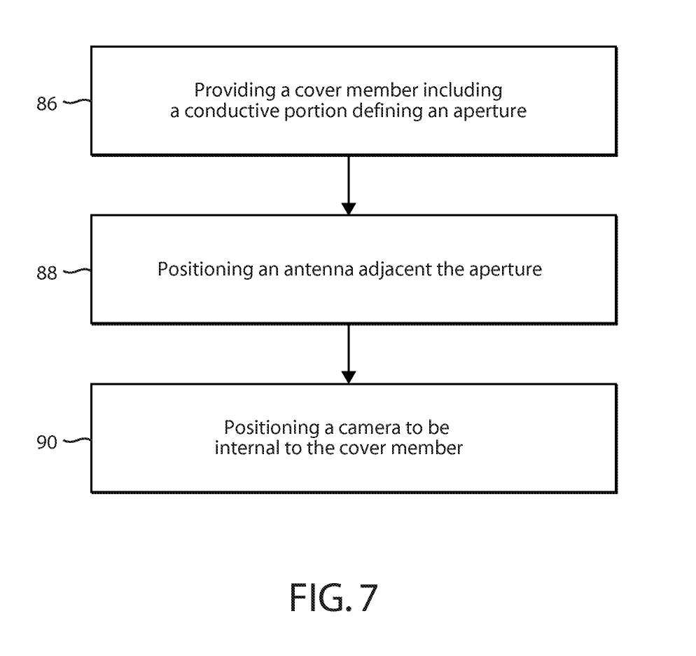

FIG. 7 illustrates a flow diagram of a method of manufacturing an apparatus according to various examples;

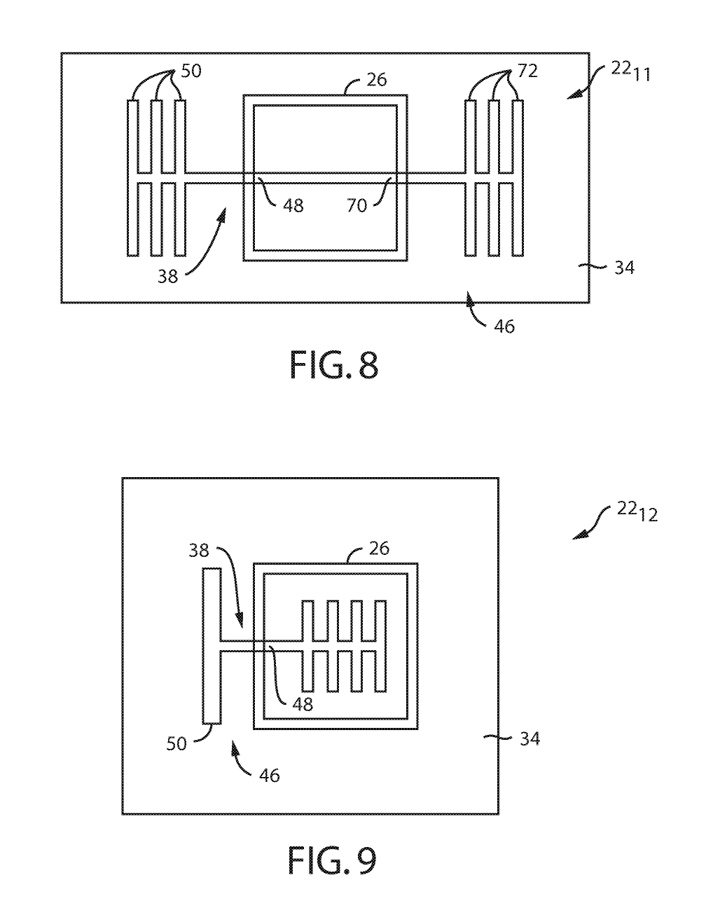

FIG. 8 illustrates a plan view of another apparatus according to various examples; and

FIG. 9 illustrates a plan view of a further apparatus according to various examples.

### DETAILED DESCRIPTION

In the following description, the wording ‘connect’ and ‘couple’ and their derivatives mean operationally connected or coupled. It should be appreciated that any number or combination of intervening components can exist (including no intervening components). Additionally, it should be appreciated that the connection or coupling may be a physical galvanic connection and/or an electromagnetic connection.

FIGS. 2, 3, 4A to 4H, 5, 6, 8 and 9 illustrate an apparatus comprising: a cover member 24 defining an exterior surface of an electronic device 10, the cover member 24 including a conductive portion 34 defining an aperture 46 enclosed by the conductive portion 34; the aperture 46 comprising: a first aperture portion 48 configured to extend across a first part 38 of an antenna 26 in a first direction 32; and a second aperture portion 50 configured to be located outside of an area defined by the antenna 26, the second aperture portion 50 extending in at least a second direction 30, different to the first direction 32, from the first aperture portion 48.

Furthermore, FIGS. 2, 3, 4A to 4H, 5, 6, 8 and 9 illustrate an apparatus comprising: a cover member 24 defining an exterior surface of an electronic device 10, the cover member 24 including a conductive portion 34 defining an aperture 46 enclosed by the conductive portion 34; the aperture 46 comprising: a first aperture portion 48 configured to extend across a first part 38 of an antenna 26 in a first direction 32; and a second aperture portion 50 configured to be located outside of an area defined by the antenna 26, wherein the first aperture portion 48 and the second aperture portion 50 have widths in a direction orthogonal to the first direction 32, the width of the second aperture portion 50 being greater than the width of the first aperture portion 48.

In more detail, FIG. 1 illustrates an electronic device 10 which may be any apparatus such as a hand portable electronic device (for example, a mobile cellular telephone, a tablet computer, a laptop computer, a personal digital assistant or a hand held computer), a non-portable electronic device (for example, a personal computer or a base station for a cellular network), a portable multimedia device (for example, a music player, a video player, a game console and so on) or a module for such devices. As used here, the term ‘module’ refers to a unit or apparatus that excludes certain parts or components that would be added by an end manufacturer or a user.

The electronic device 10 comprises an antenna arrangement 12, radio frequency circuitry 14, circuitry 16, a ground member 18, and a cover 20.

The antenna arrangement 12 includes one or more antennas that are configured to transmit and receive, transmit only or receive only electromagnetic signals. The radio frequency circuitry 14 is connected between the antenna arrangement 12 and the circuitry 16 and may include a receiver and/or a transmitter and/or a transceiver. The circuitry 16 is operable to provide signals to, and/or receive signals from the radio frequency circuitry 14. The electronic device 10 may optionally include one or more matching circuits, filters, switches, or other radio frequency circuit elements, and combinations thereof, between the antenna arrangement 12 and the radio frequency circuitry 14.

The radio frequency circuitry 14 and the antenna arrangement 12 may be configured to operate in a plurality of operational frequency bands. For example, the operational frequency bands may include (but are not limited to) Long Term Evolution (LTE) (US) (734 to 746 MHz and 869 to 894 MHz), Long Term Evolution (LTE) (rest of the world) (791 to 821 MHz and 925 to 960 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); hiper local area network (HiperLAN) (5150-5850 MHz); global positioning system (GPS) (1570.42-1580.42 MHz); US—Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EU-WCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900 (1850-1990 MHz); time division synchronous code division multiple access (TD-SCDMA) (1900 MHz to 1920 MHz, 2010 MHz to 2025 MHz), ultra wideband (UWB) Lower (3100-4900 MHz); UWB Upper (6000-10600 MHz); digital video broadcasting—handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra high frequency (RFID UHF) (433 MHz, 865-956 MHz, 2450 MHz), inductive power standard (Qi) frequencies.

A frequency band over which an antenna can efficiently operate using a protocol is a frequency range where the antenna's return loss is less than an operational threshold. For example, efficient operation may occur when the antenna's return loss is better than (that is, less than) −4 dB or −6 dB.

The circuitry 16 may include processing circuitry, memory circuitry and input/output devices such as an audio input device (a microphone for example), an audio output device (a loudspeaker for example), a display, a camera, charging circuitry, and a user input device (such as a touch screen display and/or one or more buttons or keys).

The antenna arrangement 12 and the electronic components that provide the radio frequency circuitry 14 and the circuitry 16 may be interconnected via the ground member 18 (for example, a printed wiring board). The ground member 18 may be used as a ground plane for the antenna arrangement 12 by using one or more layers of the printed wiring board. In other embodiments, some other conductive part of the electronic device 10 (a battery cover or a chassis within the interior of the cover 20 for example) may be used as the ground member 18 for the antenna arrangement 12. In some examples, the ground member 18 may be formed from several conductive parts of the electronic device 10, one part which may include the printed wiring board. The ground member 18 may be planar or non-planar.

The cover 20 has an exterior surface that defines one or more exterior visible surfaces of the electronic device 10 and also has an interior surface that defines a cavity configured to house the electronic components of the electronic device 10 such as the antenna arrangement 12, the radio frequency circuitry 14, the circuitry 16 and the ground member 18.

FIG. 2 illustrates a plan view of an apparatus 22 according to various examples. The apparatus 22 includes a cover member 24 and an antenna 26. In some examples, the apparatus 22 may not include the antenna 26 and it should be appreciated that the illustration of the antenna 26 in FIG. 2 is provided to enable the positioning of the antenna 26 relative to the cover member 24 to be described.

FIG. 2 also illustrates a Cartesian coordinate axis 28 that includes an X axis 30 and a Y axis 32 that are orthogonal to one another.

The cover member 24 is a part of the cover 20 illustrated in FIG. 1 and defines at least a part of an exterior surface of the electronic device 10. The cover member 24 is oriented parallel with the plane defined by the X axis 30 and the Y axis 32. The cover member 24 includes a conductive portion 34 and may also include other portions such as a plastic covering on the exterior of the conductive portion 34. In some examples, the cover member 24 may be a rear cover of an electronic device (and may be a rear cover for a portable electronic device such as a mobile cellular telephone or a tablet computer).

The antenna 26 forms at least a part of the antenna arrangement 12. The antenna 26 may be any suitable antenna and may be a loop antenna for example. In some examples, the antenna 26 is coupled to the radio frequency circuitry 14 illustrated in FIG. 1 to enable the electronic device 10 to perform near field communication (NFC). In other examples, the antenna 26 is coupled to the charging circuitry in the circuitry 16 to enable the electronic device 10 to perform wireless charging, for example via the standard Qi (Wireless Power Consortium).

In this example, the antenna 26 is a loop antenna that comprises a plurality of turns and defines an opening 36 therein. The antenna 26 is rectangular in shape and has a first part 38 where the antenna 26 extends parallel to the X axis 30, a second part 40 where the antenna 26 extends parallel to the Y axis 32, a third part 42 where the antenna 26 extends parallel to the X axis 30, and a fourth part 44 where the antenna 26 extends parallel to the Y axis 32. It should be appreciated that in other examples, the antenna 26 may have a different shape (for example, the antenna 26 may be circular, elliptical or have any polygonal shape when viewed in plan).

In this example, the antenna 26 is positioned underneath the cover member 24 and when the electronic device 10 is assembled, the antenna 26 is positioned internal to (that is, within) the cover 20. In other examples, the antenna 26 may be positioned on top of the cover member 24 and when the electronic device 10 is assembled, the antenna 26 is positioned external to (that is, outside of) the cover 20.

In some examples, the antenna 26 may not be oriented parallel to the plane defined by the X axis 30 and the Y axis 32 and instead, the antenna 26 may define a non-zero angle with the plane defined by the X axis 30 and the Y axis 32. Furthermore, the antenna 26 may be non-planar and have various parts extending in all three dimensions. In some examples, only the first part 38 of the antenna 26 may be positioned adjacent to the conductive portion 34 of the cover member 24 (that is, the remaining parts of the antenna 26 may be positioned remote from the conductive portion 34).

The conductive portion 34 defines an aperture 46 that is enclosed by the conductive portion 34 (when viewed in plan). In other words, the aperture 46 does not form an opening in any of the side edges of the conductive portion 34. The aperture 46 extends through the conductive portion 34 to form a non-conductive area within the conductive portion 34. The cover member 24 may include one or more non-conductive layers that extend into, over or underneath the aperture 46 (for example, to prevent the ingress of water and/or dust to the electronic device 10 via the aperture 46).

The aperture 46 includes a first aperture portion 48 and a second aperture portion 50. The first aperture portion 48 forms a slot in the conductive portion 34 having a first end 52 positioned within the opening 36 of the antenna 26 when viewed in plan. The first aperture portion 48 extends in a first direction (parallel to the Y axis 32) across the first part 38 of the antenna 26 and has a second end 54 that is positioned outside of the area of the antenna 26. In this example, the first aperture portion 48 is oriented perpendicular to the first part 38 of the antenna 26. In other examples, the first aperture portion 48 may be oriented at a different (non zero) angle to the first part 38 of the antenna 26.

The second aperture portion 50 also forms a slot in the conductive portion 34 and is configured to be located outside of the area defined by the antenna 26 when the cover member 24 and the antenna 26 are assembled. The second aperture portion 50 extends in at least a second direction (parallel to the X axis 30) that is different to the first direction, from the second end 54 of the first aperture portion 48. In this example, the second aperture portion 50 is oriented perpendicular to the first aperture portion 48.

In other examples, the second aperture portion 50 may extend from the first aperture portion 48 at a different (non zero) angle. Furthermore, the second aperture portion 50 may not be located at the second end 54 of the first aperture portion 48, but may instead extend from a location between the first end 52 and the second end 54 that is outside of the area defined by the antenna 26.

The first aperture portion 48 and the second aperture portion 50 have widths in the X axis 30 direction. The width of the second aperture portion 50 is greater than the width of the first aperture portion 48. In some examples, the widths of the first and second aperture portions 48, 50 may vary along their lengths. In these examples, the maximum width of the second aperture portion 50 is greater than the maximum width of the first aperture portion 48.

FIG. 3 illustrates a plan view of the apparatus 22 illustrated in FIG. 2 in operation where electrical current and magnetic field lines are illustrated. The antenna 26 is illustrated in schematic form (that is, as a rectangle) for clarity purposes.

Arrows labelled with reference numeral 56 represent the anti-clockwise flow of electrical current in the antenna 26. Arrows labelled with reference numeral 58 represent the clockwise flow of electrical current in the bottom surface of the conductive portion 34. Arrows labelled with reference numeral 60 represent the anti-clockwise flow of electrical current in the top surface of the conductive portion 34 around the first aperture portion 48. Arrows labelled with reference numeral 62 represent the clockwise flow of electrical current in the top surface of the conductive portion 34 around the second aperture portion 50.

The arrow labelled with reference numeral 64 and positioned within the opening 36 of the antenna 26 and the first aperture portion 48 represents the orientation of the magnetic field of the antenna 26 which is out of the diagram and towards the observer (that is, orthogonal to the X axis 30 and to the Y axis 32). The arrow labelled with reference numeral 66 represents the orientation of the magnetic field of the antenna 26 along the first aperture portion 48 and which is in the +Y direction. The arrows labelled with reference numeral 68 and positioned within the second aperture portion 50 represent the orientation of the magnetic field of the antenna 26 which is into the diagram and away from the observer (that is, orthogonal to the X axis 30 and to the Y axis 32).

In operation, electrical current flows in the antenna 26 in the anti-clockwise direction indicated by the arrows 56. The magnetic field 64, 66, 68 generated by the antenna 26 forms eddy currents (indicated by arrows 58 and 60) in the conductive portion 34. As described above with reference to FIG. 2, the first aperture portion 48 extends across the first part 38 of the antenna 26 and consequently, the eddy currents 58, 60 are cut by the first aperture portion 48 and cause the eddy currents to flow from the bottom surface to the top surface of the conductive portion 34 on the left hand side of the first aperture portion 48, and to flow from the top surface to the bottom surface of the conductive portion 34 on the right hand side of the first aperture portion 34.

Additionally, the eddy currents in the top surface of the conductive portion 34 flow around the second aperture portion 50 as indicated by arrows 62.

The aperture 46 in the conductive portion 34 provides several advantages. Firstly, the first aperture portion 48 is configured to cross the eddy currents 58, 60 and cause them to follow a longer path (relative to a conductive portion not having an aperture 46 therein). The longer path increases the impedance of the conductive portion 34 which reduces the magnitude of the eddy currents 58, 60 and thus reduces the magnetic field generated by the eddy currents 58, 60. Since the magnetic field generated by the eddy currents 58, 60 destructively interferes with the magnetic field 64, 66, 68 generated by the antenna 26, the first aperture portion 48 advantageously increases the strength of the magnetic field 64, 66, 68 generated by the antenna 26.

Secondly, the second aperture portion 50 which is located outside of the area of the antenna 26 advantageously provides a natural return path for the magnetic field 64, 66, 68 around the antenna 26. This may result in the antenna 26 having a stronger magnetic field 64, 66, 68 (relative to an apparatus where the conductive portion does not include a second aperture portion 50). The magnetic field 64, 66, 68 of the antenna 26 may be strengthened by increasing the width of the second aperture portion 50 (that is, by increasing the size of the second aperture portion 50 in the X axis 30). Furthermore, increasing the area of the second aperture portion 50 increases the magnetic field of the antenna 26.

FIGS. 4A to 4H illustrate plan views of various apparatus according to various examples. The various apparatus illustrated in FIGS. 4A to 4H are similar to the apparatus 22 and where the features are similar, the same reference numerals are used. Also illustrated is the Cartesian coordinate axis 28 for the various apparatus.

FIG. 4A illustrates a plan view of an apparatus 22₁ that differs from the apparatus 22 in that the aperture 46 includes a third aperture portion 70 that is configured to extend across the third part 42 of the antenna 26 in the −Y direction. The aperture 46 also includes a fourth aperture portion 72 that is configured to be located outside of the area defined by the antenna 26. The fourth aperture portion 72 extends in the X axis 30 from the third aperture portion 70. The third and fourth aperture portions 70, 72 are symmetrical with the first and second aperture portions 48, 50 respectively about a line of symmetry parallel with the X axis 30.

FIG. 4B illustrates a plan view of an apparatus 22₂ that differs from the apparatus 22₁ in that the aperture 46 includes an elliptical aperture portion 74 between the first aperture portion 48 and the third aperture portion 70 in the centre of the aperture 46.

FIG. 4C illustrates a plan view of an apparatus 22₃ that differs from the apparatus 22 in that the first end 52 of the first aperture portion 48 defines a circular aperture portion 76.

FIG. 4D illustrates a plan view of an apparatus 22₄ that differs from the apparatus 22₁ in that the fourth aperture portion 72 does not extend in the X axis 30 from the third aperture portion 70 and instead has the same width as the third aperture portion 70.

FIG. 4E illustrates a plan view of an apparatus 22₅ that differs from the apparatus 22₁ in that the aperture 46 includes a rectangular aperture portion 78 between the first aperture portion 48 and the third aperture portion 70 in the centre of the aperture 46.

FIG. 4F illustrates a plan view of an apparatus 22₆ that differs from the apparatus 22₃ in that the ends of the second aperture portion 50 extend in the −Y direction adjacent to the second and fourth parts 40, 44 of the antenna 26 and having parts outside the area of the antenna 26 and having parts that may extend over or under the antenna 26.

FIG. 4G illustrates a plan view of an apparatus 22₇ that differs from the apparatus 22₂ in that the second aperture portion 50 and the fourth aperture portion 72 do not extend solely in the X axis 30, but instead curve inwards towards the antenna 26.

FIG. 4H illustrates a plan view of an apparatus 22₈ that differs from the apparatus 22₅ in that the first and second aperture portions 48, 50 extend from the rectangular aperture portion 78 in the +Y direction and form a trapezium shape. Additionally, the third and fourth aperture portions 70, 72 extend from the rectangular aperture portion 78 in the −Y direction and also form a trapezium in shape.

FIG. 5 illustrates a side view of another apparatus 22₉ according to various examples. The apparatus 22₉ includes a cover member 24, an antenna 26, a ferrite sheet 80, and a camera 82. The antenna 26 is sandwiched between the ferrite sheet 80 and the cover member 24. The camera 82 is positioned under the ferrite sheet 80. Therefore, the antenna 26, the ferrite sheet 80 and the camera 82 are positioned internal to the cover member 24. In some examples, the camera 82 may also be protruding through the above mentioned layers to meet the external surface, that is, at least a part of the camera 82 may be surrounded by ferrite 80, antenna 26 and cover member 24.

As described in the preceding paragraphs, the cover member 24 includes a conductive portion 34 defining an aperture 46 therein (which may be shaped as illustrated in any of FIGS. 2, 3 and 4A to 4H, or may be shaped differently). The ferrite sheet 80 and the antenna 26 each have openings therethrough, and the camera 82 is aligned with the openings in the ferrite sheet 80, the antenna 26 and the aperture 46 to enable light to pass from the exterior of the apparatus 22₉ to the camera 82.

FIG. 6 illustrates a side view of a further apparatus 22₁₀ according to various examples. The apparatus 22₁₀ is similar to the apparatus 22₉ illustrated in FIG. 5 and where the features are similar, the same reference numerals are used. The apparatus 22₁₀ differs from the apparatus 22₉ in that the ferrite sheet 80 is positioned between the cover member 24 and the antenna 26. Furthermore, the antenna 26 and the ferrite sheet 80 are positioned external to the cover member 24 and are covered by a housing 84. The camera 82 is positioned adjacent the cover member 24 and internal to the cover member 24.

The apparatus 22₁₀ provides an advantage in that the antenna 26 and the ferrite sheet 80 are provided external to the cover member 24 and therefore do not occupy space within the electronic device 10. This may enable a manufacturer to make the electronic device 10 relatively thin.

It should be appreciated that the camera 82 illustrated in FIGS. 5 and 6 is an optional feature and may not be included in the apparatus 22₉ and 22₁₀.

FIG. 7 illustrates a flow diagram of a method of manufacturing an apparatus 22, 22₁ to 22₁₀ according to various examples. At block 86, the method includes providing a cover member 24 including a conductive portion 34 defining an aperture 46. In various examples, the conductive portion 34 may be formed by moulding plastic onto which metallisation is formed, for example, by laser direct structuring (LDS) or moulded interconnect device (MID) or by attaching a flex film circuit, having a conductive portion, to a plastic support. In other examples, the conductive portion 34 may be a piece of sheet metal, a stamped metal part, a layer of a printed wiring board, or a die casting, and so on.

At block 88, the method includes positioning an antenna 26 adjacent the aperture 46. The antenna 26 is positioned so that the first aperture portion 48 extends across the first part 38 of the antenna 26 and so that the second aperture portion 50 is located outside of the area of the antenna 26.

At block 90, the method includes (optionally) positioning the camera 82 to be internal to the cover member 24 and aligned with the apertures and openings in the cover member 24 and the antenna 26.

The blocks illustrated in the FIG. 7 may represent steps in a method and/or sections of code in a computer program. For example, a controller may execute the computer program to control machinery to perform the method illustrated in FIG. 7. The illustration of a particular order to the blocks does not necessarily imply that there is a required or preferred order for the blocks and the order and arrangement of the block may be varied. Furthermore, it may be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed. For example, FIG. 8 illustrates an apparatus 22₁₁ where the conductive portion 34 defines an aperture 46 that includes a plurality of second aperture portions 50 and/or a plurality of fourth aperture portions 72 in a sequence (that have a comb like appearance). Additionally or alternatively to the example in FIG. 8, FIG. 9 illustrates an apparatus 22₁₂ where the conductive portion 34 defines an aperture 46 having a comb-like structure adjacent the first aperture portion 48 and within the area defined by the antenna 26.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-28. (canceled)

29. An apparatus comprising:
a cover member defining an exterior surface of an electronic device, the cover member including a conductive portion defining an aperture enclosed by the conductive portion; the aperture comprising:
a first aperture portion configured to extend across a first part of an antenna in a first direction; and
a second aperture portion configured to be located outside of an area defined by the antenna, the second aperture portion extending in at least a second direction, different to the first direction, from the first aperture portion.

30. An apparatus as claimed in claim 29, wherein the second direction is orthogonal to the first direction.

31. An apparatus as claimed in claim 29, wherein the second aperture portion is located at an end of the first aperture portion.

32. An apparatus as claimed in claim 29, wherein the first aperture portion and the second aperture portion have widths, the width of the second aperture portion being greater than the width of the first aperture portion.

33. An apparatus as claimed in claim 29, wherein the aperture further comprises:
a third aperture portion configured to extend across a second part of the antenna in a third direction; and
a fourth aperture portion configured to be located outside of the area defined by the antenna, the fourth aperture portion extending in a fourth direction, different to the third direction, from the third aperture portion.

34. An apparatus as claimed in claim 29, further comprising an antenna including at least a first part, the antenna being positioned adjacent the aperture.

35. An apparatus as claimed in claim 34, further comprising charging circuitry, the antenna being coupled to the charging circuitry so as to enable the electronic device to perform wireless charging.

36. An apparatus as claimed in claim 34, further comprising radio frequency circuitry, the antenna being coupled to the radio frequency circuitry so as to enable the electronic device to perform near field communication.

9.37. An apparatus as claimed in claim 34, wherein the antenna is positioned internal to the cover member.

38. An apparatus as claimed in claim 34, wherein the antenna is positioned external to the cover member.

39. An apparatus as claimed in claim 29, further comprising a camera positioned internal to the cover member and underlying at least a portion of the aperture.

40. An apparatus as claimed in claim 29, wherein the cover member is configured to form a rear cover for the electronic device.

41. An electronic device comprising an apparatus as claimed in claim 29.

42. A method comprising:
providing a cover member defining an exterior surface of an electronic device, the cover member including a conductive portion defining an aperture enclosed by the conductive portion; the aperture comprising: a first aperture portion configured to extend across a first part of an antenna in a first direction; and a second aperture portion configured to be located outside of an area defined by the antenna, the second aperture portion extending in at least a second direction, different to the first direction, from the first aperture portion.

43. A method as claimed in claim 42, wherein the second direction is orthogonal to the first direction.

44. A method as claimed in claim 42, wherein the second aperture portion is located at an end of the first aperture portion.

45. A method as claimed in claim 42, wherein the first aperture portion and the second aperture portion have widths, the width of the second aperture portion being greater than the width of the first aperture portion.

46. A method as claimed in claim 42, wherein the aperture further comprises: a third aperture portion configured to extend across a second part of the antenna in a third direction; and a fourth aperture portion configured to be located outside of the area defined by the antenna, the fourth aperture portion extending in a fourth direction, different to the third direction, from the third aperture portion.

47. A method as claimed in any of claims 42, further comprising positioning an antenna adjacent the aperture, the antenna defining an area and including at least a first part.

48. A method as claimed in claim 47, further comprising coupling the antenna to charging circuitry so as to enable the electronic device to perform wireless charging.
